(19) United States
(12) Patent Application Publication
(10) Pub. No.: US 2018/0203853 A1
(43) Pub. Date: Jul. 19, 2018

(54) EXTENSIBLE VARIABLE ARRAY DEFINITION

(71) Applicant: International Business Machines Corporation, Armonk, NY (US)

(72) Inventors: Oluwatobi A. AJILA, Ottawa (CA); Daniel J. HEIDINGA, Ottawa (CA)

(21) Appl. No.: 15/406,315

(22) Filed: Jan. 13, 2017

(51) Int. Cl. G06F 17/30; G06F 9/445; G06F 9/455

(52) U.S. Cl. CPC G06F 17/30002; G06F 9/44557; G06F 9/45533; G06F 2009/45595; G06F 9/45504; G06F 9/4552; G06F 9/445

(57) ABSTRACT

A method, computer program product, and system includes a processor(s) generating an interface to enable communication of data elements from a first computing resource to a second computing resource. An element of the data is a data structure of variable size. To generate the interface, the processor(s) requests a layout that includes a variable array. The processor(s) locates a layout referenced by the variable array; the layout for the variable array can accommodate the data structure of variable size. The processor(s) generates the layout, which includes generating a runtime class for an element type of the data structure of variable size and generating a runtime class for the variable array. The processor generates an enclosing layout that indicates to the second computing resource, delineations between the data elements. The processor(s) communicates, via the interface, the data elements from the first computing resource to the second computing resource.

### BACKGROUND

A Java virtual machine (JVM) is an abstract computing machine that enables a computer to run a Java program. A challenge in computing technology is to provide interfaces that enable program code managed by a JVM to communicate with program code that is not managed by the JVM. One such endeavor, called Project Panama, aims to provide for native interconnect between code managed by the JVM and application program interfaces (APIs) for libraries not managed by the JVM. One such challenge in this endeavor is to make an API flexible enough to handle a range of native library types, including C, C++, Windows, Linux, and Solaris, without making the API too difficult to use. The effort includes creating tools for generating Java code for binding libraries, to accommodate subtle, platform-specific differences. Project Panama seeks to provide an alternative to Java Native Interface (JNI) for interfacing Java code to code written in unmanaged languages and proposes a new way to interface a JVM with native APIs. For example, one goal of Project Panama is to provide the ability to describe and interact with variable length datatypes such as file formats (Java class file) network formats (e.g., IP header) and interface description languages (e.g., Protobuf). A challenge in achieving this interconnectivity is creating a standard way to describe structured data, as different languages have different ways of describing data and different platforms interpret the same native types.

### SUMMARY

Shortcomings of the prior art are overcome and additional advantages are provided through the provision of a method for generating a communication interface between two computer resources. The method includes, for instance: generating, by one or more processors, an interface, wherein the interface enables communication of data elements from a first computing resource to a second computing resource, wherein an element of the data elements comprises a data structure of variable size, the generating comprising: based on the element of the data elements comprising the data structure of variable size, requesting, by one or more processors of the first computing resource, a layout comprising a variable array; locating, by the one or more processors, a layout referenced by the variable array, wherein the layout for the variable array can accommodate the data structure of variable size; generating, by the one or more processors, the layout, wherein the generating comprises: generating a runtime class for an element type of the data structure of variable size; and generating a runtime class for the variable array; and generating, by the one or more programs, an enclosing layout, wherein the enclosing layout indicates to the second computing resource, delineations between the data elements; and communicating, by the one or more processors, via the interface, the data elements from the first computing resource to the second computing resource.

Methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a workflow illustrating certain aspects of an embodiment of the present invention;

FIG. 2, a designation which refers to both FIG. 2A and FIG. 2B, is an example of one or more programs generating a runtime class for the variable array, in accordance with one or more aspects of an embodiment of the present invention;

FIG. 3 is an example of one or more programs getting a variable array, in accordance with one or more aspects of an embodiment of the present invention;

FIG. 4 is an example an illustration of a layout description that includes basic variable arrays, in accordance with one or more aspects of an embodiment of the present invention;

FIG. 5, a designation which refers to both FIG. 5A and FIG. 5B, depicts certain aspects of an implementation of a privileged variable array in accordance with an embodiment of the present invention;

FIG. 6 depicts one embodiment of a computing node that can be utilized in a cloud computing environment;

FIG. 7 depicts a cloud computing environment according to an embodiment of the present invention; and

FIG. 8 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

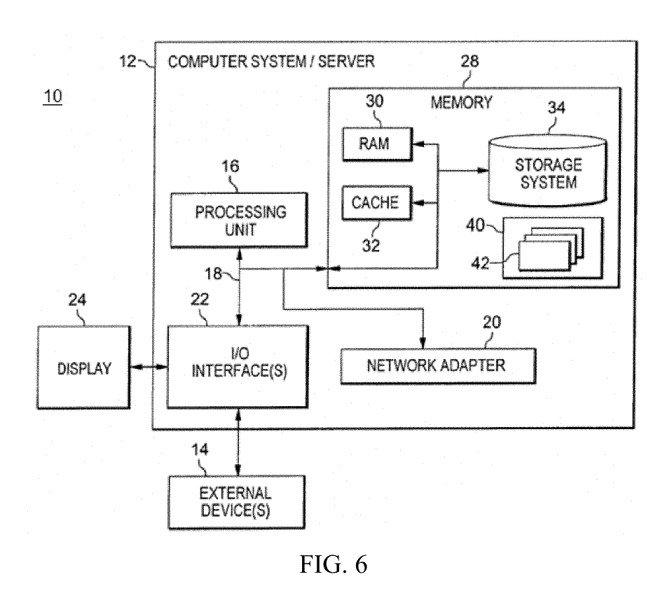

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 6 as program/utility 40, having a set (at least one) of program modules 42, may be stored in memory 28.

In order to describe native data in a general way, regardless of platform or language, one can utilize the layout descriptor language (LDL). The main goals of the language are: 1) describing data access disciplines; 2) describing the data layout; and 3) attaching type information to the data. A shortcoming of LDL is that existing methods related to its utilization enable description of data layouts, but cannot describe data structures with variable size. Describing data structures with variable size has been a challenge because there are many different types of variable sized structures, including but not limited to, length prefixed string structures, transmission control protocol (TCP) headers, and java class file formats. An advantage of aspects of embodiments of the present invention is that they provide a method, computer program product, and system for extending existing LDL and layout functionality to describe a wide array of variable sized structures. This advantage is inextricably tied to computing at least because this aspect improves communications between different computer systems by providing an interface that enables program code managed by a first system, to communicate with program code that is not managed by the first system, even when the communication includes data structures of variable size. In an embodiment of the present invention, the first system may comprise a JVM.

Embodiments of the present invention provide definitions for variable sized structures that are flexible, as they allow for user controlled length, which can be based on a field, or other data reachable by a field, in the layout. An advantage of this approach is that it provides safety as the runtime can do bounds checks on the variable sized array. Embodiments of the present invention can also take advantage of just in time (JIT) optimizations where bounds checks can be pulled out of loops. A JIT compiler compiles the bytecodes into native machine code, compiling it “just in time” to run. In an embodiment of the present invention, when a method has been compiled, the JVM calls the compiled code of that method directly instead of interpreting it. Embodiments of the present invention also provide an efficient layout without compromising Java safety.

An advantage of certain aspects of an embodiment of the present invention is that although these aspects can be utilized to grow and shrink arrays at runtime, these aspects additionally describe memory layouts of data, where the sizes of arrays are defined at runtime, either by a value in the data, or by an operation applied to a value or effective address (e.g., location) of a value in the data.

Aspects of certain embodiment of the present invention provide various advantages in inter-system and inter-format communications. For example, embodiments of the present invention can be utilized to describe complex structures that will run on a JVM. Additionally, embodiments of the present invention can describe data of variable size, regardless of the position of the variable sized data in the structure. For example, embodiments are not limited to describing only variable sized arrays at the end of a structure. Additionally, embodiments of the present invention introduce formats that are efficient because they do not include a complex notation that poses parsing issues. Instead, embodiments of the present invention can be implemented with ease and efficiency.

Although, as noted above, existing technologies lack functionality related to describing data structures with variable size, existing layout descriptions (LD) contain a description of native data structure (written in LDL). Layouts represent how data structures are arranged in memory in the form of facades (i.e., java interfaces that represent the underlying data). The layouts provide accessors to read and modify the data. Thus, LDL describes how native data is laid out and how to access it. The existing grammar for LDL is reproduced below.

“Qualified Name” {‘,’ “[Field Name][Type] {‘[‘Number of Elements’]’} ‘:’ (Size |‘pointer’|‘Layout’ Name)”}

Each field above has a defined meaning. Qualified Name is the fully qualified name of the layout being described, e.g., “com.ibm.shapes.Square.” IBM® is a registered trademark of International Business Machines Corporation, Armonk, N.Y., US. Field Name is the name of the field defined in the layout, if the field name is omitted, then no accessor is generated for it. Type is the JNI type (e.g., jint, jshort, jbyte, etc.). Number of Elements specifies the number of elements in an array dimension, with multidimensional arrays arranged in row-major order. Size is the size of the field in bits and for arrays, Size is the size of a single element of the leaf type. The special keyword pointer is used for a pointer. Name specifies the name of a defined layout.

Below are examples of how LDL can be utilized to describe: 1) a basic struct, i.e., a complex data type declaration that defines a physically grouped list of variables to be placed under one name in a block of memory, 2) a struct that includes a layout with array fields, and 3) a struct that includes nested structures.

Below is the struct “Point2D”:

struct Point {
uint32_t x;
}

The corresponding LD is: “Point”, “x:jint:32”, “y:jint:32”

Below is a struct that includes an array:

struct A {
uint32_t x;
uint32_t y[10]; //this is an array of fields
}

The corresponding LD is: “A”, “x:jint:4”, “y[10]:jint:40”

Below is a struct that includes nested structures:

struct Line {
Point start;
Point end;
}

The corresponding LD is: “Line”, “start:Point:8”, “end:Point:8”

Aspects of certain embodiments of the present invention include one or more programs generating three types of variable sized arrays. These variable arrays, along with the associated LDL, represent a wide variety of variable sized structures and file formats. Thus, in embodiments of the present invention, one or more programs generate three interfaces that can be utilized to represent a wide variety of variable sized structures and file formats. These interfaces include: 1) a basic variable array; 2) a complex variable array; and 3) a privileged variable array.

In an embodiment of the present invention, one or more programs generates a basic variable array and utilizes this interface to represent an access pattern for a single dimension of variable sized repeating types of variable length, where length is determined by a value in a preceding integral header. As advantage of this aspect is that there is no restriction on where or how many variable arrays may be placed within a layout, except that the header precedes the variable array. In a basic variable array, in accordance with an embodiment of the present invention, the header, identified as a name between square brackets, is declared before the variable sized array. The header type is an intergral type, including a byte, short, char, int, and/or long, with a positive value. In an embodiment of the present invention, the header type is not nested in another type. Also, the program code declares the basic variable array, VarArray, in an enclosing layout rather than being created on its own.

An example of a basic variable array appears below:

public interface VarArray<T extends Layout> extends LayoutType {
//no public factory methods
getLength( )
at(long)
put(long, T)
sizeof( )
toString( )
}

The LDL notation for describing a variable array is shown in the following example for a Pascal string.

LD:

“PascalStr”,
“length:jbyte:1”, //<-- header
“data:Byte[length]:0” //<-- variable sized array (with Byte element
type)

where size is determined by preceding length field

The LD above will generate the following facade:

@LayoutDesc({“length:jbyte:1”,“data:Byte[length]:0”})
public interface PStr extends Layout {

interface EffectiveAddress {

public abstract EA length( );
public abstract EA data( );

}

public PStr.EffectiveAddress EA( );

public long sizeof( );
public abstract byte length( );//header getter
public abstract VarArray<Byte> data( );//VarArray
public abstract void length(byte val);//header setter
@Override
public String toString( );
}

In an embodiment of the present invention, the runtime performs bounds checking on the variable sized array to protect it from buffer overflows. Below is an example of certain requirements of this format.

“Attributes”,//<-- Enclosing layout

“attrNameIndex:jshort:2”,

“attrLength:jint:4”,

“info:Byte[attrLength]:0”//<--VarArray

Below is an example of the usage of the above example.

PStr str=Layout.getLayout (PStr.class);//create a runtime instance of the layout

str.bindLocation(new Location(new byte[ ] {5,1,2,3,4,5}));//bind the layout to a location

byte length=str.length( );//header field

VarArray<Byte>data=str.data( );//VarArray with Byte as element type

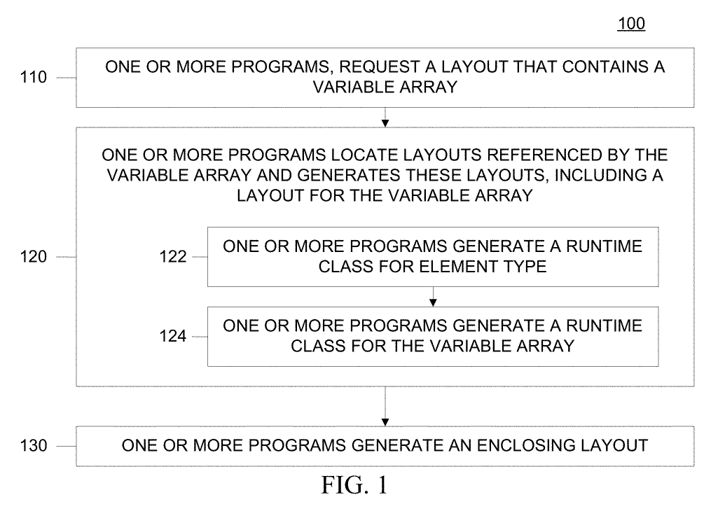

FIG. 1 is workflow 100 that illustrates certain aspects of the generation of a basic variable array, VarArray, in an embodiment of the present invention. As illustrated in FIG. 1, one or more programs (executed by one or more processors) request a layout that contains a variable array (110). In an embodiment of the present invention, the program code may utilize “Layout.getLayout( . . . )” in order to request the layout.

In an embodiment of the present invention, one or more programs locate layouts referenced by the variable array and generate these layouts, including a layout for the variable array (e.g., VarArray class) (120). In an embodiment of the present invention, program code referred to as LayoutFactory finds all layouts that it references and generate them, including the VarArray class. As understood by one of skill in the art, runtime classes of a layout type are created by the LayoutFactory implemented in a class called LayoutHelper. In an embodiment of the present invention, the LayoutHelper class creates all runtime classes in a separate classLoader (LayoutHelper.ImplClassLoader) in a “com.ibm.layout.gen” package directory. This implementation protects generated classes from naming conflicts and ensures their fields cannot be reflected. The following is an example of a call hierarchy for loadLayoutClass:

com.ibm.layout.Array1D.getArray1D(Class<T>, long)//instanciate 1D array

com.ibm.layout.Array2D.getArray2D(Class<T>, long, long)//instanciate for 2D array

com.ibm.layout.Layout.getLayout(Class<T>)//instanciate layout

com.ibm.layout.LayoutHelper.genLayoutImpl(Class<T>)//initializes static fields in the com.ibm.layout.LayoutHelper.ImplClassLoaderloadLayoutClass(Class<? extends Layout>)//generates runtime layout class

The loadLayoutClass method generates the runtime class for the specified layout interface (Class<? extends Layout>layoutInterface) by: 1) returning a cached class if it has been previously generated by the virtual machine; 2) generating required classes (i.e., layouts that are referenced by the layoutInterface); and 3) generating the bytecodes for the current layout and define the class (i.e., using ClassLoader.defineClass( . . . )).

In an embodiment of the present invention, the factory methods getArray1D, getArray2D and getLayout are responsible for instantiating the generated class. Instances of facades may have the following naming convention: “[LayoutName]Impl” for layout arrays they are “[ElementLayoutName]1DImpl”. One or more programs can generate bytecode utilizing Bytecode generation using the ASM framework. In one aspect, there is no bytecode generation for java primitive arrays, those are loaded from class files, which can be stored, in an embodiment of the present invention, in a package, including but not limited to the “com.ibm.layout.gen” package.

Returning to FIG. 1, in an embodiment of the present invention, as part of generating the layout for the variable array (e.g., VarArray class), the one or more programs generate a runtime class for element type (122).

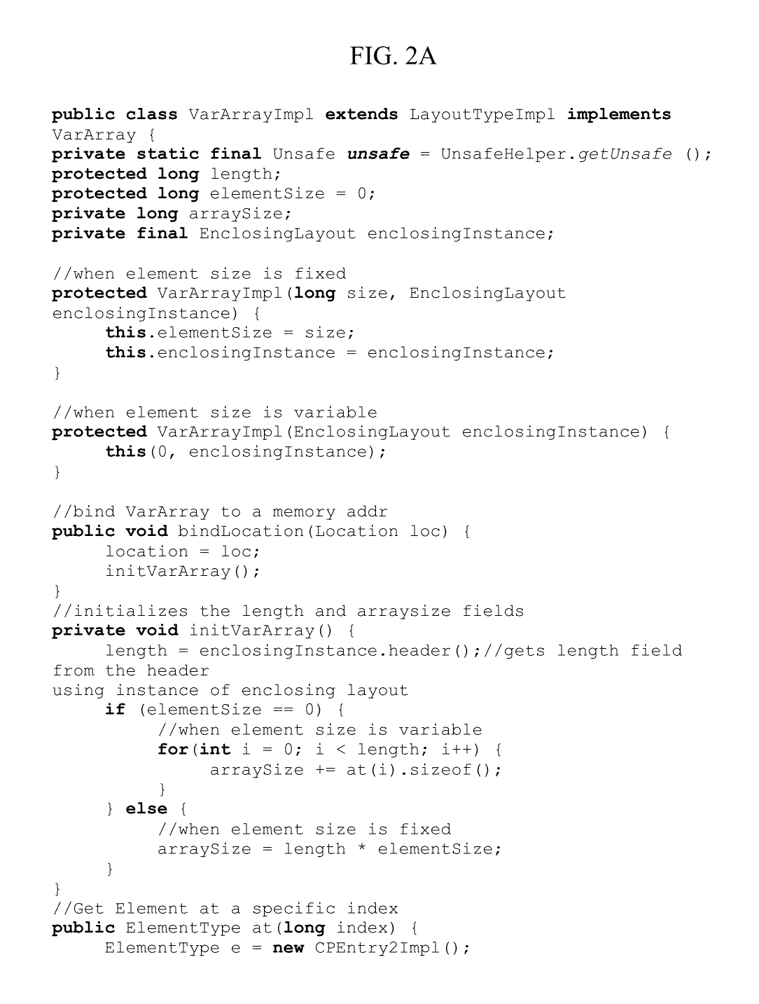

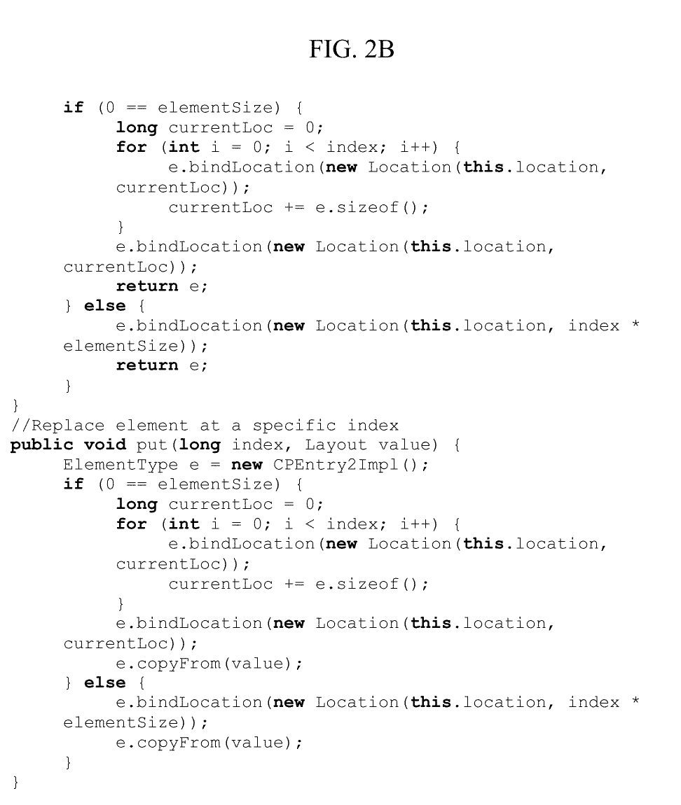

In an embodiment of the present invention, the one or more programs, as part of generating the layout for the variable array (e.g., VarArray), generate a runtime class for the variable array (124). FIG. 2, which includes FIG. 2A and FIG. 2B, is an example of one or more programs generating a runtime class for the variable array, i.e., a sample implementation runtime class for a variable array.

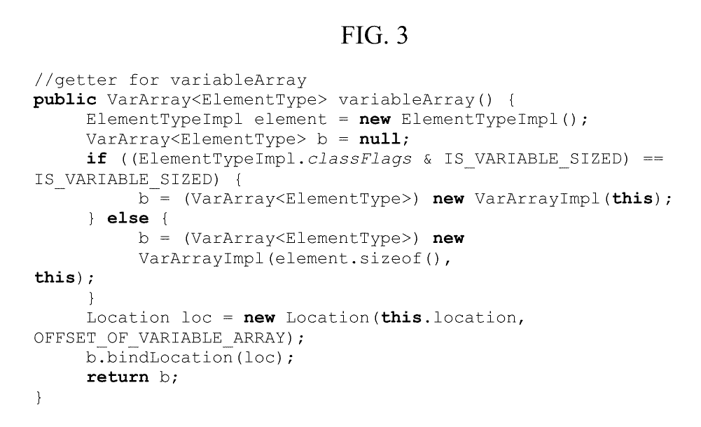

Returning to FIG. 1, in an embodiment of the present invention, the one or more programs generate an enclosing layout (130). FIG. 3 is an example of implementation of one or more programs getting a variable array, i.e., a sample implementation for VarArray getter.

In an embodiment of the present invention, the program code generates additional fields in the interface that follow the variable array. To differentiate the fields in the layout, the program code places with a waypoint and an offset. Because the variable array, by its very nature, varies in length, a fixed off-set is not utilized to differentiate between fields. Rather, the program code utilizes a waypoint, which is a defined marker that represents a relative position. The one or more programs place a waypoint after every variable sized array so that way any field that occurs after a variable sized field can be identified with a waypoint and an offset.

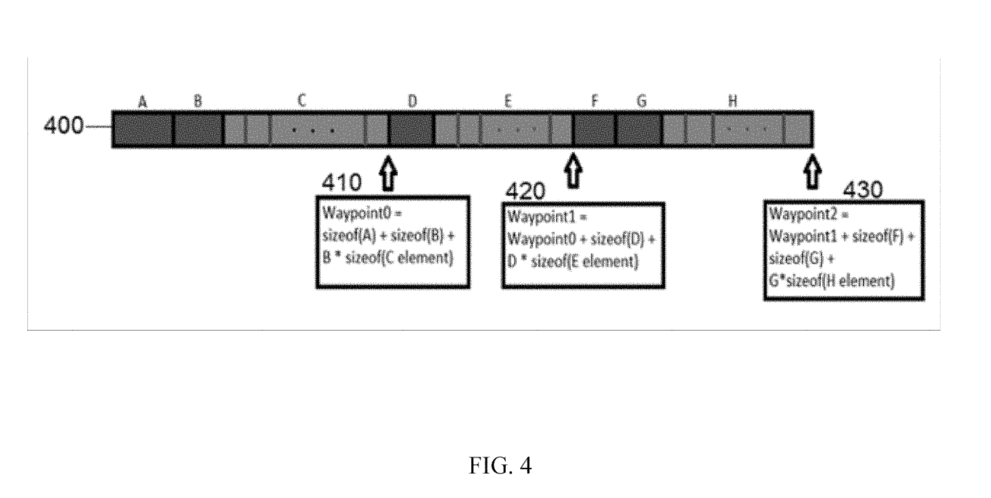

FIG. 4 is an illustration of an LD 400 that includes the described basic variable arrays. As seen in this figure, waypoints separate various fields. The LD, “ExampleLayout”, illustrated in FIG. 4 separates various entities into fields A-H. Below is the LD relevant to FIG. 4:

“ExampleLayout”,

“A, jbyte, 1”,

“B, jbyte, 1”,

“C, Byte[B], 0”,

“D, jbyte, 1”,

“E, Byte[D], 1”,

“F, jbyte, 1”,

“G, jbyte, 1”,

“H, Byte[G], 1”,

FIG. 4 also illustrates three waypoints: Waypoint0 410, Waypoint1 420, and Waypoint2 430. Waypoint0 410, which differentiates between elements C and D, is equal to the size of element A, the size of element B, and B multiplied by the size of the C element. Waypoint1 420, which differentiates between E and F, is equal to Waypoint0 410, with D multiplied by the size of the E element. Waypoint2 430, which signals the end of element H, is Waypoint1 420 plus the size of the F element, the size of the G element, and G multiplied by the size of the H element.

Another interface utilized in an embodiment of the present invention is a complex variable array. This interface represents an access pattern for a single dimension of variable sized repeating types of variable length, where length is determined by a user defined operation applied to a value in a preceding integral header, as seen below. By generating and utilizing this interface, one or more programs in an embodiment of the present invention are able to describe a broader range of variable type structures because in one aspect, a user can implement a function that will be applied to the preceding header to determine the size of the variable sized array. The runtime ensures that the resulting value is valid.

Below is an example of the syntax utilized in an embodiment of the present invention:

public interface ComplexVarArray<T extends Layout> extends
VarArray<T>

{

abstract long operation(long headerValue);

}

Below is an illustration of a complex variable array interface in an embodiment of the present invention when utilized for a constant pool count in Java Class file:

“jcfr1”,
“magic:jint:4”,
“minor:jshort:2”,
“major:jshort:2”,
“cpCount:jshort:2”,
“cp:CPEntry[ConstantPool cpCount]:0” //size is determined by
cpCount − 1
public interface ConstantPool<T extends Layout> extends

ComplexVarArray<T> {

default long operation(long headerValue) {

//users implementation of the operation applied to the

integral value in the header

return headerValue − 1;

}

}

In an embodiment of the present invention, in generating a complex variable array, a ComplexVarArray, the program code builds on top of the functionality of Basic Variable Array and User Defined Layouts. User defined layout functionality enables a user to subclass the generated facades to add additional functionality and User Defined Layouts inherit from all interfaces and generated facades. One or more programs generate a complex variable array that defines a variable sized array, where the length is determined by an operation applied to a value in a header. To generate the complex variable array, the program code performs the aspects illustrated in FIG. 1, but additionally, solicits the user to provide an interface, the subclasses ComplexVarArray, which provides an implementation of “operation( . . . )”. In an embodiment of the present invention, during initialization, when header value is read in, the one or more programs apply the operation defined by the user to the value, and the one or more programs use this operation and value to determine the number of elements in the variable sized array.

Below is an example of how the one or more programs initialize the length and array side of the fields, in an embodiment of the present invention. As noted below, the program code gets a length field from the header using an instance of an enclosing layout. The length of the field is based on the operation and varies based on whether the element size is variable or fixed.

//initializes the length and arraysize fields
private void initVarArray( ) {

//gets length field from the header using instance of enclosing

layout

length = operation(enclosingInstance.header( )); //applies

operation to header

if (elementsize == 0) {

//when element size is variable
for(int i = 0; i < length; i++) {

arraySize += at(i).sizeof( );

}

} else {

//when element size is fixed
arraySize = length * elementSize;

}

}

In an embodiment of the present invention, the one or more programs generate a privileged variable array, which is an interface that represents an access pattern for single dimension of variable sized repeating types of variable length, where length is determined by a user defined operation applied to a value from a location specified by a preceding header. Below is an example of the interface, PriviledgedVarArray.

public interface PriviledgedVarArray<T extends Layout> extends

VarArray<T> {

abstract long operation(EA headerAddr);

}

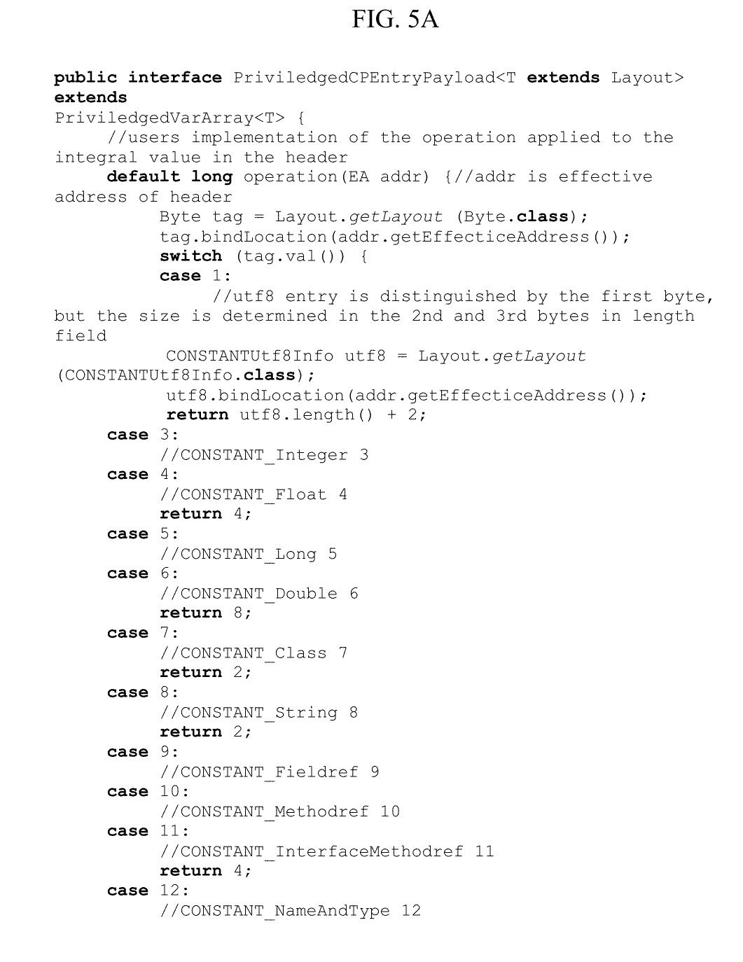

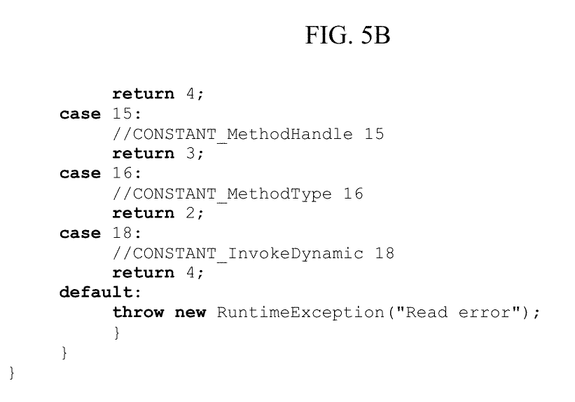

A difference between this embodiment and a complex variable array, in that in a privileged variable array, one or more programs pass an effective address of a header into a user defined operation. Thus, the header is flexible in that there is no requirement that it is of an integral type. This flexibility enables the user and the program code to define variable sized structures where the size may be defined by multiple values. Below is an example of Java pool constant entries defined in a layout of an embodiment of the present invention. FIG. 5, which includes FIG. 5A and FIG. 5B, provides an additional example of an implementation of a privileged variable array.

“CPEntry”,

“tag:jbyte:1”,

“info:Byte[PriviledgedCPEntryPayload tag]:0”

In an embodiment of the present invention, a complex variable array is a variation of the ComplexVarArray where a parameter for an (e.g., operation ( . . . )) is not the value of the header, but the effective address of the header, which the program code can bind to a layout. The implementation returns a value (e.g., a long), representing the number of elements in the array. Below is an example program code utilized to initialize a privileged variable array, PriviledgedVarArray, which includes initializing the length and the size of the arrays in the fields.

//initializes the length and arraysize fields
private void initVarArray( ) {

//gets effective address from the header using instance of

enclosing layout

length = operation(enclosingInstance.EA( ).header( ));

//applies operation

if (elementsize == 0) {

//when element size is variable
for(int i = 0; i < length; i++) {

arraySize += at(i).sizeof( );

}

} else {

//when element size is fixed
arraySize = length * elementSize;

}

Embodiments of the present invention include a computer-implemented method, a computer program product, and a computer system that generate interfaces to enable communication of variable sized data structures between computing resources. In an embodiment of the present invention, one or more programs executed on at least one processing circuit of a first computing resource generate an interface. The interface enables communication of data elements from the first computing resource to a second computing resource. An element of the data elements includes a data structure of variable size. To generate the interface, the one or more programs request a layout comprising a variable array based on the element of the data elements comprising the data structure of variable size. The one or more programs locate a layout referenced by the variable array, where the layout for the variable array can accommodate the data structure of variable size. The one or more programs generate the layout, by generating a runtime class for an element type of the data structure of variable size, generating a runtime class for the variable array, and generating an enclosing layout, where the enclosing layout indicates to the second computing resource, delineations between the data elements. The one or more programs communicate, via the interface, the data elements from the first computing resource to the second computing resource.

In an embodiment of the present invention, the first computing resource is managed by a computing node that does not manage the second computing resource.

In an embodiment of the present invention, the computing node includes a virtual machine.

In an embodiment of the present invention, the delineations include waypoints and offsets.

In an embodiment of the present invention, the one or more programs additionally utilize runtime to perform a bounds checks on the variable sized array.

In an embodiment of the present invention, in generating the interface, the one or more programs also append an integral header to the interface that includes a value. The integral header precedes the data structure of variable size. The one or more programs receive a user defined operation. In an embodiment of the present invention that includes the value and the operation, one or more programs of the second computing resource initialize the interface by determining a length of the data structure of variable size by applying the user defined operation to the value.

In an embodiment of the present invention, in generating the interface, the one or more programs also append a header to the interface that includes a location specifying a value, where the header precedes the data structure of variable size. The one or more programs receive a user defined operation. In an embodiment of the present that includes this value and receives the operation, one or more programs of the second computing resource initialize the interface by determining a length of the data structure of variable size by applying the user defined operation to the value specified by the location.

Referring now to FIG. 6, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the one or more programs generating the interfaces can be understood as cloud computing node 10 (FIG. 6) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

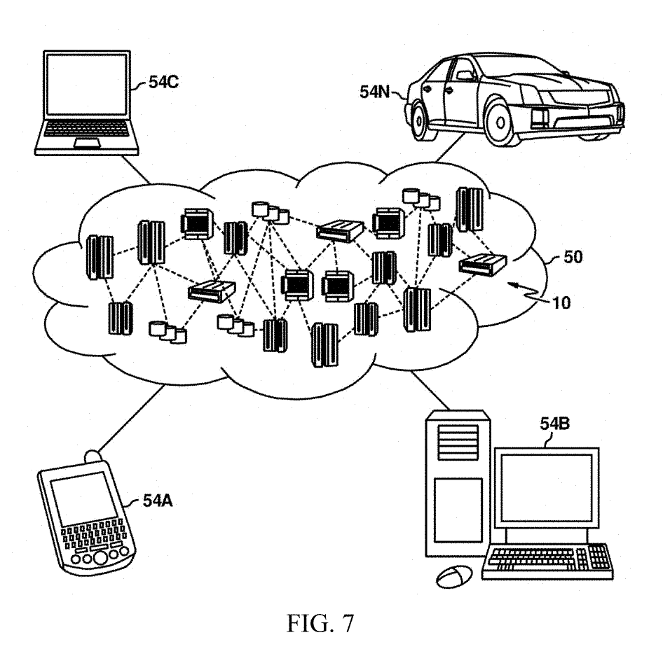

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

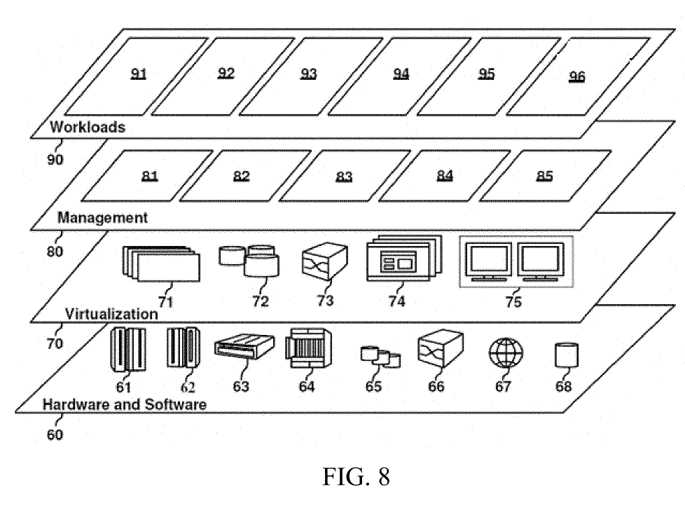

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generating and interface to communicate variable sized data between computing systems 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RANI), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
generating, by one or more processors, an interface, wherein the interface enables communication of data elements from a first computing resource to a second computing resource, wherein an element of the data elements comprises a data structure of variable size, the generating comprising:
based on the element of the data elements comprising the data structure of variable size, requesting, by one or more processors of the first computing resource, a layout comprising a variable array;
locating, by the one or more processors, a layout referenced by the variable array, wherein the layout for the variable array can accommodate the data structure of variable size;
generating, by the one or more processors, the layout, wherein the generating comprises:
generating a runtime class for an element type of the data structure of variable size; and
generating a runtime class for the variable array; and
generating, by the one or more programs, an enclosing layout, wherein the enclosing layout indicates to the second computing resource, delineations between the data elements; and
communicating, by the one or more processors, via the interface, the data elements from the first computing resource to the second computing resource.

2. The computer-implemented method of claim 1, wherein the first computing resource is managed by a computing node that does not manage the second computing resource.

3. The computer-implemented method of claim 2, wherein the computing node comprises a virtual machine.

4. The computer-implemented method of claim 1, wherein the delineations comprise waypoints and offsets.

5. The computer-implemented method of claim 1, further comprising:
utilizing, by the one or more processors, runtime to perform a bounds checks on the variable sized array.

6. The computer-implemented method of claim 1, wherein generating the interface further comprises:
appending, by the one or more processors, an integral header to the interface comprising a value, wherein the integral header precedes the data structure of variable size; and
receiving, by the one or more processors, a user defined operation.

7. The computer-implemented method of claim 6, further comprising:
based on the communicating, initializing, by one or more processors of the second computing resource, the interface, the initializing comprising:
determining, by the one or more processors, a length of the data structure of variable size by applying the user defined operation to the value.

8. The computer-implemented method of claim 1, wherein generating the interface further comprises:
appending, by the one or more processors, a header to the interface comprising a location specifying a value, wherein the header precedes the data structure of variable size; and
receiving, by the one or more processors, a user defined operation.

9. The computer-implemented method of claim 8, further comprising:
based on the communicating, initializing, by one or more processors of the second computing resource, the interface, the initializing comprising:
determining, by the one or more processors, a length of the data structure of variable size by applying the user defined operation to the value specified by the location.

10. A computer program product comprising:
a computer readable storage medium readable by one or more processors and storing instructions for execution by the one or more processors for performing a method comprising:
generating, by the one or more processors, an interface, wherein the interface enables communication of data elements from a first computing resource to a second computing resource, wherein an element of the data elements comprises a data structure of variable size, the generating comprising:
based on the element of the data elements comprising the data structure of variable size, requesting, by one or more processors of the first computing resource, a layout comprising a variable array;
locating, by the one or more processors, a layout referenced by the variable array, wherein the layout for the variable array can accommodate the data structure of variable size;
generating, by the one or more processors, the layout, wherein the generating comprises:
generating a runtime class for an element type of the data structure of variable size; and
generating a runtime class for the variable array; and
generating, by the one or more programs, an enclosing layout, wherein the enclosing layout indicates to the second computing resource, delineations between the data elements; and
communicating, by the one or more processors, via the interface, the data elements from the first computing resource to the second computing resource.

11. The computer program product of claim 10, wherein the first computing resource is managed by a computing node that does not manage the second computing resource.

12. The computer program product of claim 11, wherein the computing node comprises a virtual machine.

13. The computer program product of claim 10, wherein the delineations comprise waypoints and offsets.

14. The computer program product of claim 10, wherein generating the interface further comprises:
appending, by the one or more processors, an integral header to the interface comprising a value, wherein the integral header precedes the data structure of variable size; and
receiving, by the one or more processors, a user defined operation.

15. The computer program product of claim 14, the method further comprising:
based on the communicating, initializing, by one or more processors of the second computing resource, the interface, the initializing comprising:
determining, by the one or more processors, a length of the data structure of variable size by applying the user defined operation to the value.

16. The computer program product of claim 10, wherein generating the interface further comprises:
appending, by the one or more processors, a header to the interface comprising a location specifying a value, wherein the header precedes the data structure of variable size; and
receiving, by the one or more processors, a user defined operation.

17. The computer program product of claim 16, the method further comprising:
based on the communicating, initializing, by one or more processors of the second computing resource, the interface, the initializing comprising:
determining, by the one or more processors, a length of the data structure of variable size by applying the user defined operation to the value specified by the location.

18. A system comprising:
a memory;
one or more processors in communication with the memory; and
program instructions executable by the one or more processors via the memory to perform a method, the method comprising:
generating, by the one or more processors, an interface, wherein the interface enables communication of data elements from a first computing resource to a second computing resource, wherein an element of the data elements comprises a data structure of variable size, the generating comprising:
based on the element of the data elements comprising the data structure of variable size, requesting, by one or more processors of the first computing resource, a layout comprising a variable array;
locating, by the one or more processors, a layout referenced by the variable array, wherein the layout for the variable array can accommodate the data structure of variable size;
generating, by the one or more processors, the layout, wherein the generating comprises:
generating a runtime class for an element type of the data structure of variable size; and
generating a runtime class for the variable array; and
generating, by the one or more programs, an enclosing layout, wherein the enclosing layout indicates to the second computing resource, delineations between the data elements; and
communicating, by the one or more processors, via the interface, the data elements from the first computing resource to the second computing resource.

19. The system of claim 18, wherein the first computing resource is managed by a computing node that does not manage the second computing resource.

20. The system of claim 19, wherein the computing node comprises a virtual machine.
